(19) United States
(12) Patent Application Publication
(10) Pub. No.: US 2015/0154897 A1
(43) Pub. Date: Jun. 4, 2015

(54) Controller and Display Apparatus with Improved Performance and Associated Methods

(71) Applicant: Silicon Laboratories Inc., Austin, TX (US)

(72) Inventors: Mohamed M. E. Elsayed, Austin, TX (US); Kenneth W. Fernald, Austin, TX (US)

(21) Appl. No.: 14/555,510

(22) Filed: Nov. 26, 2014

Related U.S. Application Data
(63) Continuation-in-part of application No. 13/720,037, filed on Dec. 19, 2012.

(51) Int. Cl. G09G 3/18

(52) U.S. Cl. CPC G09G 3/18; G09G 2310/0297; G09G 2330/021

(57) ABSTRACT

An apparatus includes a multiplexed liquid crystal display (LCD) controller. The LCD controller operates in at least first and second phases of operation. The LCD controller drives a first plurality of signal lines to a first set of voltages during the first phase of operation and to a second set of voltages during the second phase of operation. The LCD controller selectively couples to a node at least some of the plurality of signal lines between the first and second phases of operation depending on data provided to the LCD controller.

### CROSS-REFERENCE TO RELATED APPLICATIONS

This application is a continuation-in-part of copending U.S. patent application Ser. No. 13/720,037, filed on Dec. 19, 2012, titled “Controller and Display Apparatus with Improved Performance and Associated Methods,” attorney docket number SILA345. The foregoing application is incorporated by reference in its entirety for all purposes.

### TECHNICAL FIELD

The disclosed concepts relate generally to display apparatus and related methods. More particularly, the disclosure relates to apparatus for displays and drivers with improved performance through segment resetting, and associated methods.

### BACKGROUND

Various types of electronic apparatus and systems use displays. Displays provide the capability to present information to the user of the apparatus or system. In some instances, displays also provide the functionality of accepting information, such as input, from the user.

One type of display is the liquid crystal display (LCD). LCDs are ubiquitous in various electronic apparatus and displays. Compared to other types of display, such as fluorescent or light-emitting diode (LED) displays, LCDs consume less power, which contributes in part to their relative popularity.

In some LCDs, the order of LCD phases has been rearranged to reduce power consumption of the LCD. The details of this technique are understood by person of ordinary skill in the art. As an example, a non-rearranged LCD might have phases arranged as [0, 1, 2, 3, 4, 5, 6, 7]. To reduce the number of voltage-level transitions of the LCD common lines, the order of the LCD phases might be rearranged as [0, 2, 4, 6, 1, 3, 5, 7]. This technique may provide ˜17% power savings compared to non-rearranged LCDs.

### SUMMARY

A variety of embodiments are contemplated according to the disclosure. An apparatus according to one exemplary embodiment includes a multiplexed liquid crystal display (LCD) controller. The LCD controller operates in at least first and second phases of operation. The LCD controller drives a first plurality of signal lines to a first set of voltages during the first phase of operation and to a second set of voltages during the second phase of operation. The LCD controller selectively couples to a node at least some of the plurality of signal lines between the first and second phases of operation depending on data provided to the LCD controller.

According to another exemplary embodiment, an apparatus includes a multiplexed liquid crystal display (LCD) that has at least first and second phases of operation. The apparatus further includes a controller coupled to the LCD. The controller selectively performs segment resetting between the first and second phases of operation of the LCD depending on data provided to the LCD controller.

According to yet another exemplary embodiment, a method of operating an LCD includes operating the LCD in a first phase of operation, and after operating the LCD in the first phase of operation, selectively performing segment resetting based on data provided to the LCD controller. The method further includes operating the LCD in a second phase of operation after performing selective segment resetting.

### BRIEF DESCRIPTION OF THE DRAWINGS

The appended drawings illustrate only exemplary embodiments and therefore should not be considered as limiting its scope. Persons of ordinary skill in the art appreciate that the disclosed concepts lend themselves to other equally effective embodiments. In the drawings, the same numeral designators used in more than one drawing denote the same, similar, or equivalent functionality, components, or blocks.

FIG. 1 illustrates a circuit arrangement according to an exemplary embodiment.

FIG. 2 shows a multiplexed LCD for use in an exemplary embodiment.

FIG. 3 shows segment capacitances in an exemplary embodiment.

FIGS. 4A-4D depict LCD control signals according to an exemplary embodiment.

FIGS. 5A-5C illustrate conventional LCD segment switching.

FIGS. 6A-6C depict segment resetting between phases according to an exemplary embodiment.

FIG. 7 shows a block diagram of a circuit arrangement for segment resetting using a variety of resetting schemes according to exemplary embodiments.

FIGS. 8A-8D depict a set of waveforms used to determine majority voltage(s) used in segment resetting according to exemplary embodiments.

FIG. 9 shows a block diagram of controller 15 according to an exemplary embodiment.

FIG. 10 illustrates an LCD waveform transition in an exemplary embodiment.

FIGS. 11A-11B show segment switching based on LCD data values according to an exemplary embodiment.

FIGS. 12A-12B depict segment resetting based on LCD data values according to an exemplary embodiment.

FIG. 13 illustrates a flow diagram for a data-dependent method of LCD segment switching according to an exemplary embodiment.

FIG. 14 shows an LCD for common-line scan ordering according to an exemplary embodiment.

FIG. 15 depicts conventional common-line scanning.

FIG. 16 illustrates a common-line scan order according to an exemplary embodiment.

FIG. 17 shows a flow diagram for a data-dependent method of common-line scanning according to an exemplary embodiment.

### DETAILED DESCRIPTION

The disclosed concepts relate generally to displays used in electronic apparatus and/or systems. More specifically, the disclosed concepts provide apparatus and methods for LCDs and/or controllers or drivers with improved performance, e.g., lower or relatively low power consumption compared to conventional LCDs/drivers.

The improved performance results in part from segment resetting, that is, returning charge on at least some segments to known states between phases of operation of the controller or LCD. Segment resetting may be applied to both common and segment lines to short segment capacitors or couple the capacitors to known or desired voltages, as described below in detail. Segment resetting reduces power dissipation, as described below in detail.

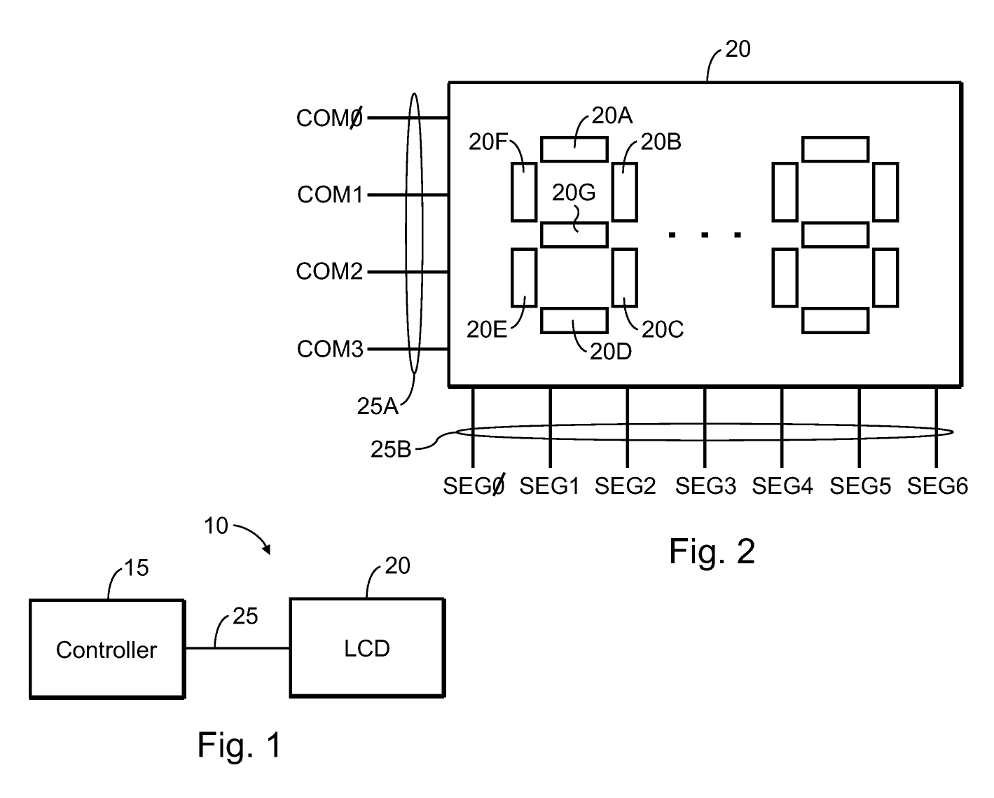

FIG. 1 illustrates a circuit arrangement 10 according to an exemplary embodiment. Circuit arrangement 10 includes controller or driver 15 and LCD or LCD panel 20. Controller 15 controls the operation of LCD 20 using a coupling mechanism 25. Coupling mechanism 25 allows communication of control signals from controller 15 to LCD 20. In addition, coupling mechanism 25 may provide communication of other signals between controller 15 and LCD 20, for example, status signals, as desired.

Coupling mechanism 25 may take a variety of forms, as desired. Generally, coupling mechanism 25 includes conductive elements that provide for electrical connection or coupling between controller 15 and LCD 20. For example, in some embodiments, coupling mechanism 25 may include printed circuit board (PCB) traces. As another example, in some embodiments, coupling mechanism 25 may include wires, deposited metal or other conductor, etc.

As noted, in exemplary embodiments, LCD 20 is a multiplexed LCD. FIG. 2 shows a multiplexed LCD 20 for use in an exemplary embodiment. LCD 20 includes multiple seven-segment displays or digits, in a configuration well known to persons of ordinary skill in the art. For example, the left digit has seven segments labeled as 20A-20G. LCD controller 15 (not shown) drives the segments 20A-20G, thus displaying numeric (and some alphabetic) information on the display. Similar driving techniques apply to other parts of LCD 20.

Driving the segments in each of the digits in LCD 20 would ordinarily use a relatively large number of signal lines. LCD 20, however, uses a multiplexing technique to reduce the number of signal lines and, thus, the number of conductors or coupling mechanisms. In the example shown, controller 15 (not shown) uses two sets of signals to control or drive LCD 20: common signals or lines (labeled as COM0 through COM3), and segment signals or lines (labeled as SEG0 through SEG6).

Note that the number and configuration of the common and segment lines or signals in FIG. 2 provides merely an example. Other configurations that use other numbers of signals may be used in other embodiments, as desired. Furthermore, note that LCD 20 in FIG. 2 shows merely an example of a display. Other configurations of displays may be used, as persons of ordinary skill in the art understand. For example, in some embodiments, displays may have the capability to display alphabetic information, alphanumeric information, arbitrary shapes or annunciators, etc.

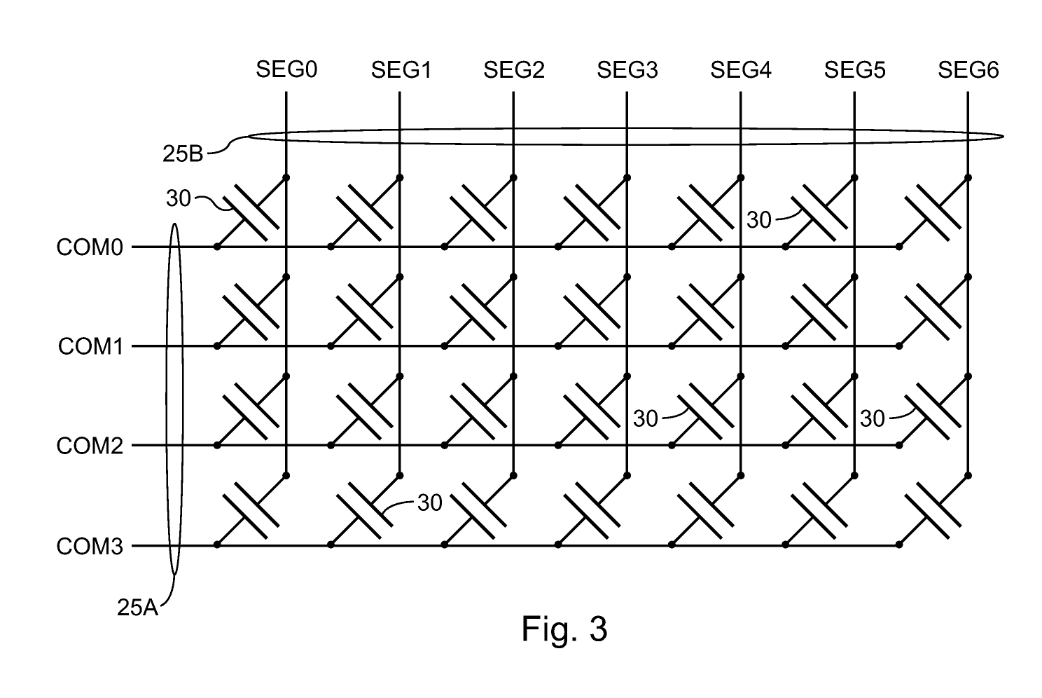

LCD 20 has capacitances 30 associated with its segments, as FIG. 3 shows. Specifically, FIG. 3 represents the LCD segments as capacitances 30 between the common and segment lines. In other words, the segments of LCD 20 give rise to corresponding capacitances 30 arranged at the intersections of the common and segment lines. For example, the segment coupled between common line COM0 and segment line SEG0 (at the top-left corner of FIG. 3) is represented by a capacitor 30, and so on. By using multiplexing, this arrangement reduces the number of signal lines that the controller uses to drive LCD 20. It does, however, make the drive waveforms more complex, as the controller changes the waveforms as a function of time (even for displayed results that do not change) to perform multiplexing. Controller 15 controls or drives LCD 20 by resetting the segments of LCD 20, as described below in detail.

Note that FIG. 3 shows capacitances 30 for an exemplary LCD. The example shown assumes four common lines, COM0-COM3, and seven segment lines, SEG0-SEG6. As persons of ordinary skill in the art understand, however, other LCD configurations (e.g., different numbers of segments), different numbers of common and/or segment lines, etc., may be used, and may result in different configurations and/or numbers of capacitances 30, and may also result in different waveforms used to drive the common and/or segment lines.

In exemplary embodiments, driver 15 uses time-division multiplexing to control LCD 20. The number of time divisions (or phases) in the multiplexing scheme is generally twice the number of common lines used in LCD 20. For example, a 2× multiplex LCD has two common lines, COM0 and COM1, and uses four phases, whereas a 4× multiplex LCD has common lines COM0 through COM3 and uses eight phases.

Controller 15 uses different voltage levels to generate the appropriate waveforms for driving LCD 20, sometimes described in terms of “bias” of the LCD. For example, a “half bias” LCD may have three bias voltage levels, e.g., 0, ½V, and V, where V may denote a voltage such as the supply voltage, with ½V often derived from the supply voltage, for example, by using a resistor divider. A ⅓ bias LCD, as another example, may have voltage levels 0, ⅓V, ⅔V, and V, and so on.

As persons of ordinary skill in the art understand, however, the above examples are non-limiting, and merely illustrative. Other voltage generation schemes or biasing and/or multiplexing techniques may be used, depending on the desired specifications for the controller and/or LCD.

LCDs typically respond to the root mean square (RMS) voltage applied to the segments, rather than to attributes like the polarity of the voltage. Thus, an LCD segment may be “ON” when the RMS voltage applied to that segment exceeds a threshold. (The threshold depends on factors such as the design or specifications of LCD 20, as persons of ordinary skill in the art understand.) Controller 15 provides voltages or signals to LCD 20 to turn “ON” appropriate segments for a desired display.

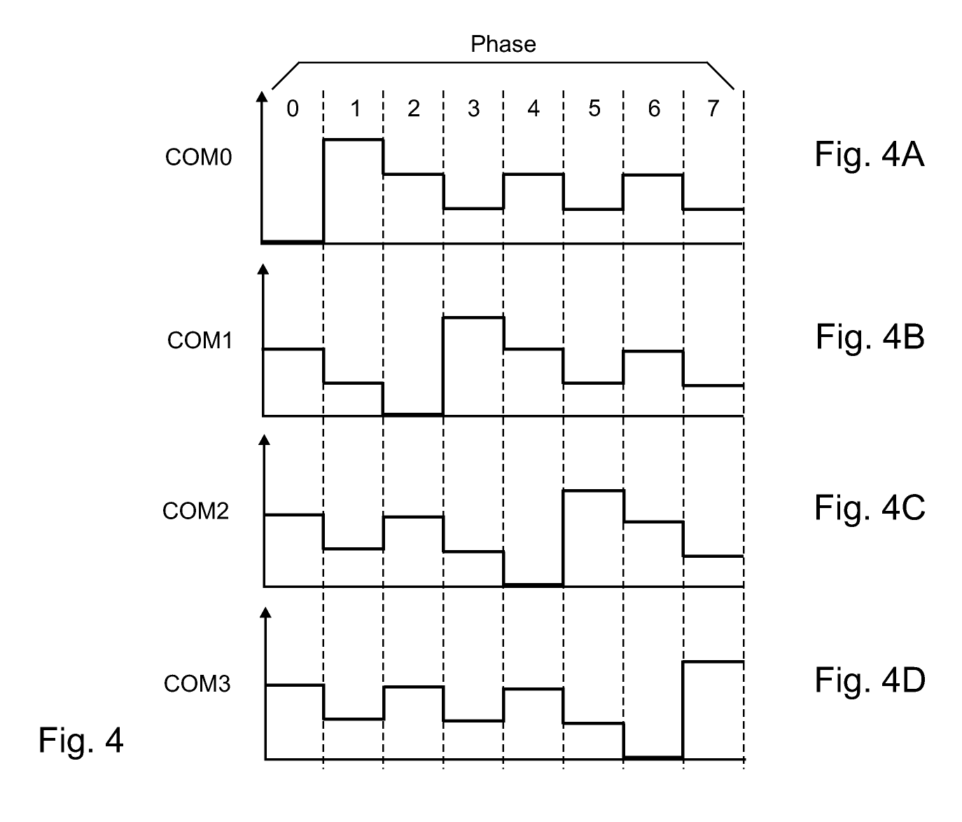

Furthermore, LCD 20 may suffer damage if subjected to a net DC voltage for a relatively extended period of time. To meet those specifications, controller 15 applies voltage pulses or signals of varying levels to the segments of LCD 20, as FIG. 4 illustrates.

FIGS. 4A-4D show conventional waveforms applied to the common lines for controlling an LCD. The controller corresponding to the waveforms in FIG. 4 has four common lines, COM0-COM3, and eight phases of operation, denoted as phases 0 through 7. The phases occupy time-frames delimited by the vertical dashed lines.

The segment lines are driven by voltages (not shown in FIG. 4) that vary depending on the data for the desired resulting display. As FIG. 4 shows, the common lines are driven by time-shifted versions of the same voltage waveform. More specifically, the waveform in FIG. 4B is a time-shifted (to the right) version of the waveform in FIG. 4A. Similarly, the waveform in FIG. 4C is a time-shifted version of the waveform in FIG. 4B. Finally, the waveform in FIG. 4D constitutes a time-shifted version of the waveform in FIG. 4C.

As noted above, the disclosed controllers reduce power dissipation by reducing the charge drawn from the power source (e.g., a battery for portable or low-power apparatus) or supply by resetting segments between phases. Conventional LCD controllers, in contrast, charge and discharge the segment capacitors by using more charge supplied from the power source.

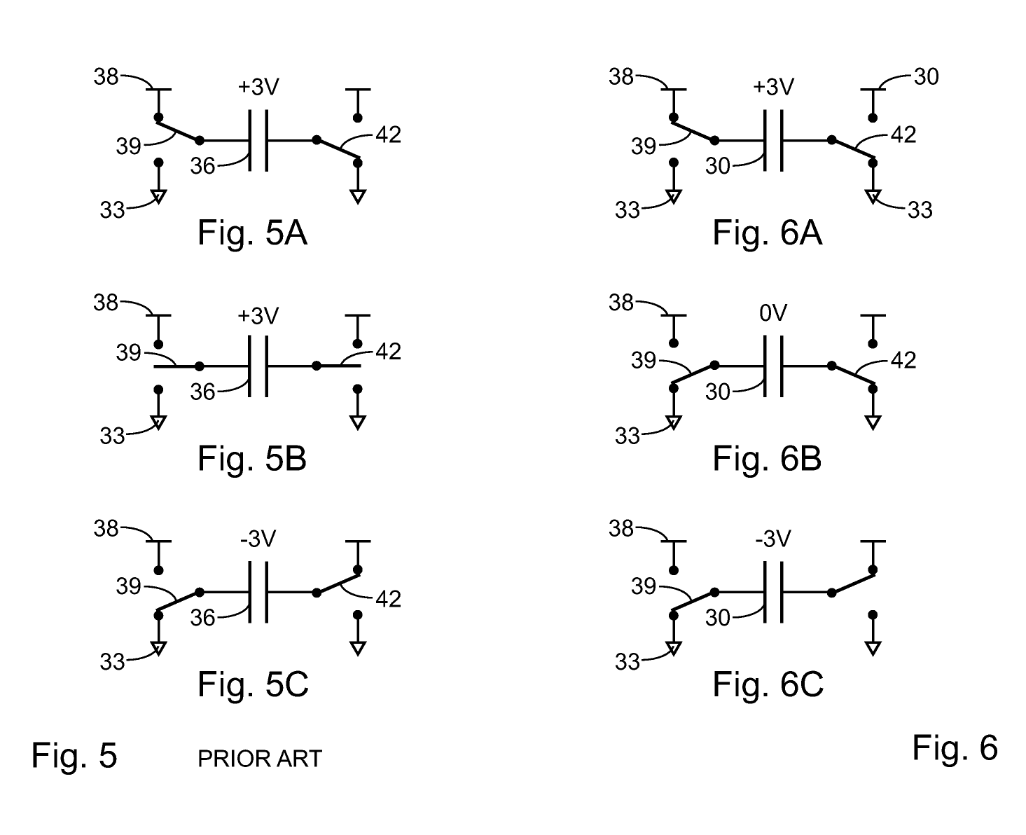

FIG. 5, consisting of FIGS. 5A-5C, depicts an example of segment switching in a conventional LCD. More specifically, FIG. 5 shows how the voltage across segment capacitance 36 is switched in response to commands or control signals from a controller (not shown). Switches 39 and 42 are controlled switches, and respond to the LCD controller (not shown). Switches 39 and 42 switch the terminals of capacitor 36 between a supply 38 (in this case, a 3V supply) and a ground potential.

In FIG. 5A, switch 39 couples the left terminal of capacitor 36 to supply 38. Similarly, switch 42 couples the right terminal of capacitor 30 to ground 33. Supply 38 provides charge to capacitor 36. As a result, capacitor 36 charges ultimately to the supply voltage, 3V, with a time constant that depends on circuit component values and parasitic elements, as persons of ordinary skill in the art understand. Supply 38 provides an absolute value (without regard to the direction of current flow) charge of Q=CV, where V=3 volts, or Q=3C, where C is the value of the capacitor.

Conventional LCD controllers typically use a break-before-make switch control scheme, as FIG. 5B illustrates. Thus, before changing or switching the voltage across capacitor 36, the controller causes switch 39 and switch 42 to open. Assuming negligible charge leakage, the voltage across capacitor 36 remains at about 3V, i.e., the terminal charging voltage from the configuration in FIG. 5A.

In FIG. 5C, the controller (not shown) causes switch 39 to couple to ground the left terminal of capacitor 36. Similarly, switch 42 couples the right terminal of capacitor 36 to supply 38. Using the sign convention from FIG. 5A, the capacitor now charges to −3V. Thus, supply 38 provides an absolute value charge of Q=CV, where V=2×3=6 volts, or Q=6C.

In exemplary embodiments, one may reduce the charge supplied from supply 30 by resetting segments between the phases of operation of the controller (or LCD). FIG. 6, which includes FIGS. 6A-6C, shows details of such an operation according to an exemplary embodiment.

More specifically, FIG. 6 shows how the voltage across segment capacitance 30 is switched in response to commands or control signals from controller 15 (not shown). Switches 39 and 42 are controlled switches, and respond to controller 15. Switches 39 and 42 switch the terminals of capacitor 30, with a capacitance C, between a supply 38 (in the example shown, a 3V supply) and a ground potential.

Referring to FIG. 6A, during one phase of operation, say, phase 0, controller 15 causes switch 39 to couple the left terminal of capacitor 30 to supply 38. Similarly, controller 15 causes switch 42 to couple the right terminal of capacitor 30 to ground. As a result, supply 38 provides charge to capacitor 30. As a result, capacitor 30 charges ultimately to the supply voltage, 3V in this example, with a time constant that depends on circuit component values and parasitic elements. Supply 38 provides an absolute value (without regard to the direction of current flow) charge of Q=CₛV, where Cₛ represents the capacitance of capacitor 30, V=3 volts, which yields Q=3Cₛ.

Referring to FIG. 6B, the figure illustrates how switches 39 and 42 are configured between the first phase (phase 0, in this example), and the next phase (phase 1, in this example). More specifically, switch 39 and switch 42 are controlled by controller 15 so as to couple the terminals of capacitor 30 to desired nodes, points, or voltages (generally, Vᵣₛₜ). In the example shown, switch 39 and switch 42 are controlled by controller 15 so as to couple the terminals of capacitor 30 to ground potential, i.e., to ground 33.

In this manner, the segment corresponding to capacitor 30 is reset. This operation does not draw any current or charge from supply 38, as any current flows from one terminal of capacitor 30 through a node (in this example, ground 33), and to the other terminal of capacitor 30.

Finally, referring to FIG. 6C, controller 15 causes switch 39 to couple the left terminal of capacitor 30 to ground 33. Similarly, controller 15 causes switch 42 to couple the right terminal of capacitor 30 to supply 38. Using the sign convention from FIG. 6A, the capacitor now charges to −3V. Because the change of voltage across capacitor 30 is from 0 volts to −3V (or −Vₛ, generally, with Vₛ denoting the supply voltage), supply 38 provides an absolute value charge of Q=CₛV, where V=3 volts, or Q=3Cₛ.

Consequently, the segment resetting described above causes a reduction in the total charge that supply 38 provides to charge and discharge capacitor 30. As a result, the power dissipation in the LCD and/or controller/LCD combination is reduced. The segment resetting between the two phases of operation thus provides longer battery life for situations where supply 38 constitutes a battery, for example, in portable or low power applications.

Note that capacitor 30 shown in FIG. 6 constitutes one segment capacitor. As persons of ordinary skill in the art understand, and as FIG. 3 illustrates, a plurality of capacitors 30 may be used in a practical implementation. The segment resetting described above may be applied to capacitors 30 in such an arrangement, as desired. Furthermore, as persons of ordinary skill in the art understand, referring to the switching examples illustrated in FIG. 5 and FIG. 6, a controller may switch the segments of an LCD between voltage values other than 3V and 0V.

Rather than coupling capacitor 30 to ground to effect segment resetting, other arrangements may be used. Generally speaking, segment resetting may be performed by coupling capacitors 30 together, or coupling capacitors 30 together to a voltage source or potential (e.g., bias voltage), Vᵣₛₜ.

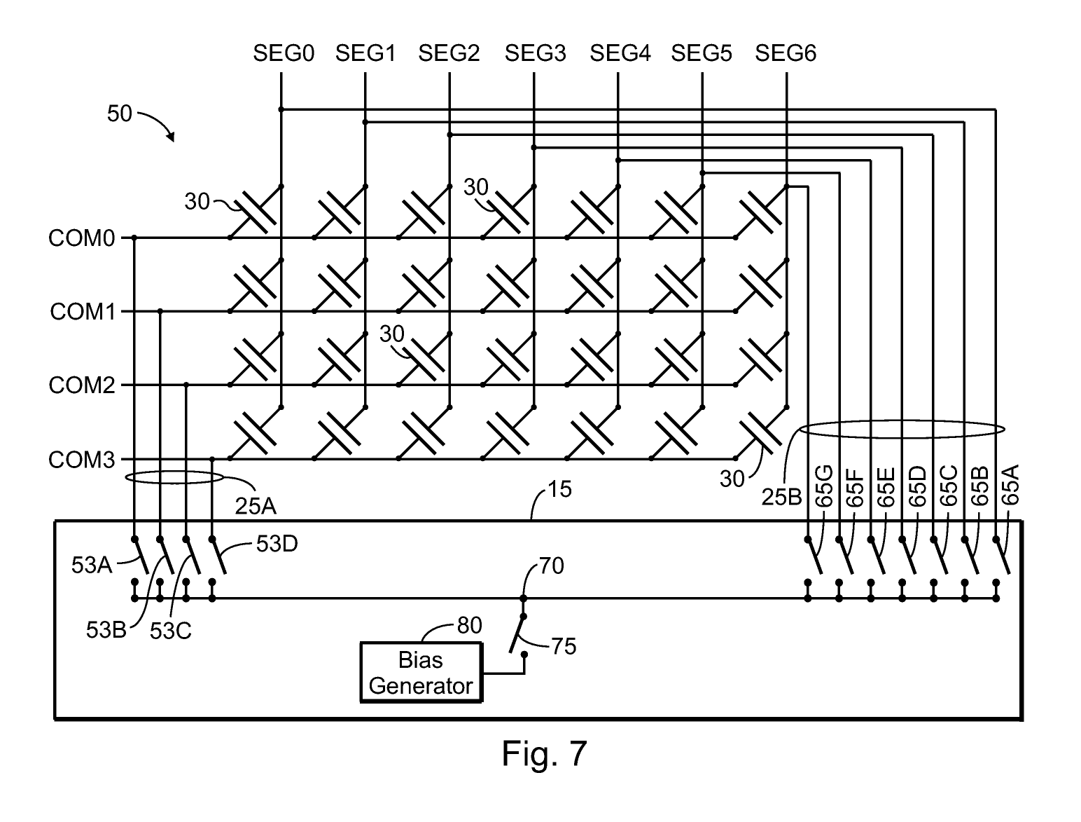

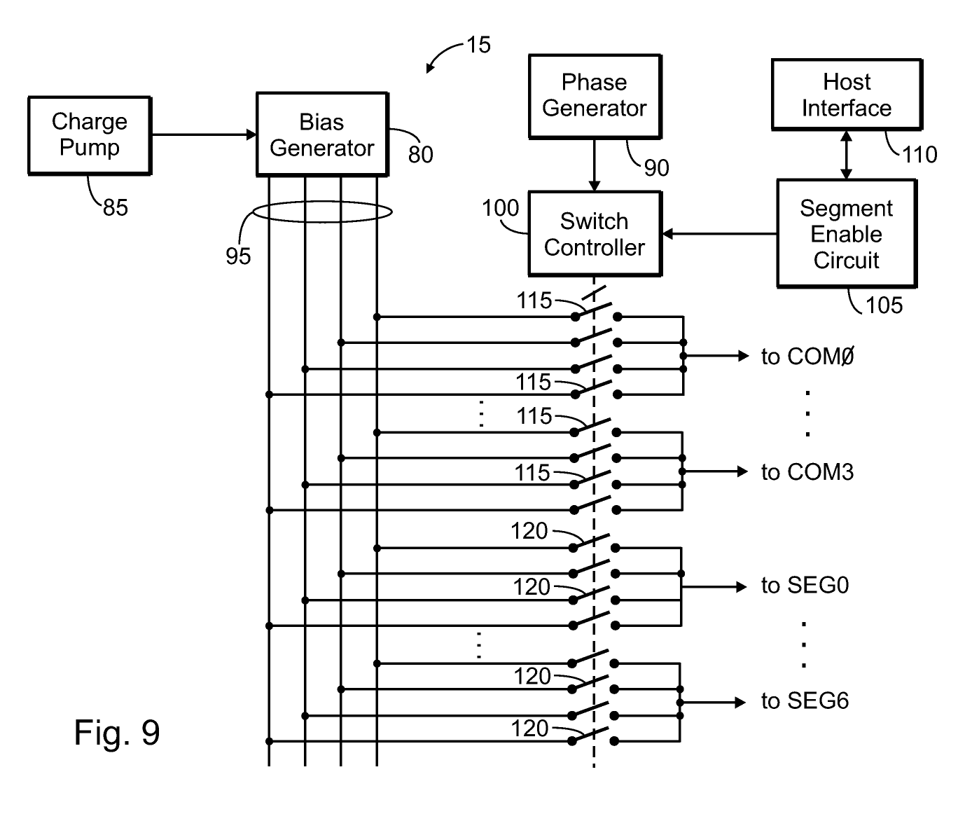

FIG. 7 shows a block diagram of a circuit arrangement 50 for segment resetting using a variety of resetting schemes. Note that, to facilitate presentation of the concepts, FIG. 7 shows one output of bias generator 80, although as persons of ordinary skill in the art understand, bias generator 80 may have multiple outputs (not shown), coupled to the common and segment lines through additional switches (not shown). A more general block diagram of controller 15 appears in FIG. 9.

Referring back to FIG. 7, the array of capacitors 30 is similar to the configuration shown in FIG. 3. Similar to FIG. 3, the example shown in FIG. 7 includes four common lines (COM0-COM3) and seven segment lines (SEG0-SEG6). Referring to FIG. 7, controller 15 includes a number of switches that allow coupling common lines and/or segment lines to node 70. More specifically, controller 15 includes switches 53A-53D, which couple to COM0-COM3, respectively, and also to node 70.

By controlling one or more switches 53A-53D, controller 15 can couple one or more common lines COM0 through COM3, respectively, to node 70. For example, causing switches 53A and 53C to close couples common lines COM0 and COM2 to couple to node 70. As another example, closing switches 53A-53D causes all of the common lines (COM0-COM3) to couple to node 70.

Controller 15 also includes switches 65A-65G. Switches 65A-65G couple to segment lines SEG0-SEG6, respectively. By controlling one or more switches 65A-65G, controller 15 can couple one or more segment lines SEG0 through SEG6, respectively, to node 70. For example, causing switches 65B and 53F to close couples segment lines SEG1 and SEG5 to couple to node 70. As another example, closing switches 65A-65G causes all of the segment lines (SEG0-SEG6) to couple to node 70.

Furthermore, controller 15 includes switch 75, which can couple node 70 to the output of bias generator 80. Bias generator 80 may provide a desired bias level at its output, such as ground potential, or other desired potentials (e.g., majority voltages, as described below in detail), generally, Vᵣₛₜ, as noted above. Controller 15 can couple the output of bias generator 80 to node 70 by controlling switch 75.

In exemplary embodiments, controller 15 uses switches 53A-53D, switches 65A-65G, and switch 75 to perform segment resetting between two phases of operation. Using switches 53A-53D, switches 65A-65G, and switch 75 together with bias generator 80 allows a variety of segment resetting operations. The choice of segment resetting depends on factors such as design and performance specifications, for example, the desired degree of power dissipation reduction, level of parasitics present, etc.

In some embodiments, controller 15 causes switches 53A-53D and switches 65A-65G to close in order to perform segment resetting. Closing switches 53A-53D and switches 65A-65G causes common lines COM0-COM3 and segment lines SEG0-SEG6 to couple together via node 70 (or couple to node 70). Switch 75 remains open. This configuration causes segment resetting by bringing common lines COM0-COM3 and segment lines SEG0-SEG6 to the same voltage or potential, thus returning the charge on all segment capacitances coupled between COM0-COM3 and SEG0-SEG6 to zero.

In some embodiments, controller 15 causes switches 53A-53D, switches 65A-65G, and switch 75 to close in order to perform segment resetting. Closing switches 53A-53D and switches 65A-65G causes common lines COM0-COM3 and segment lines SEG0-SEG6 to couple together via node 70 (or couple to node 70). Switch 75 couples node 70 to the output of bias generator 80. Thus, in this configuration, segment resetting is performed by applying the voltage at the output of bias generator 80 to common lines COM0-COM3 and segment lines SEG0-SEG6.

A variety of output voltages or potentials may be supplied by bias generator 80 (generally, Vᵣₛₜ, as noted above). In some configurations, segment resetting is performed by bias generator 80 coupling node 70 to ground potential via switch 75. In some embodiments, segment resetting is performed by bias generator 80 coupling node 70 to a desired potential via switch 75. The potential might constitute a bias voltage, a majority voltage (as described below in detail), or some other voltage. As persons of ordinary skill in the art understand, FIG. 9 shows one possible implementation of controller 15. A variety of other implementations are possible, and contemplated. For example, in some embodiments, switch 75 may not be used and bias generator 80 may not drive a potential onto mode 70, or bias generator 80 may continuously drive a potential onto node 70.

As noted above, FIG. 7 presents a block diagram. Actual implementation of controller 15 might use additional switches or other components for the common segment lines, as desired. Furthermore, bias generator 80 may provide more bias voltages, depending on the type of LCD panel, type of control, and the like, as desired. FIG. 9 shows a more general block diagram of controller 15.

One aspect of the disclosure relates to performing segment resetting in a manner that reduces power dissipation because of parasitics, e.g., parasitic elements, imperfections, etc. In some situations, parasitic elements in the circuit, for example, parasitic capacitances in driver 15, interconnects (e.g., coupling mechanism 25 in FIG. 1), and/or LCD 20, may contribute to additional charge transfer from supply 38. The increased power dissipation causes a drain on supply 38. Especially in low power or portable applications, the additional drain may be a relatively significant disadvantage by, for example, shortening battery life.

In some embodiments, parasitic capacitors coupled to or associated with the signal lines coupling the controller to the LCD may exist. If during segment resetting these signal lines are coupled to ground between phases, as described above, the parasitic capacitors coupled to those signal lines will be discharged. When those signals are then driven to the appropriate bias voltage during the successive phase, current from the battery or power supply will be consumed to recharge the parasitic capacitors, causing segment resetting to potentially generate additional power losses due to parasitic capacitors.

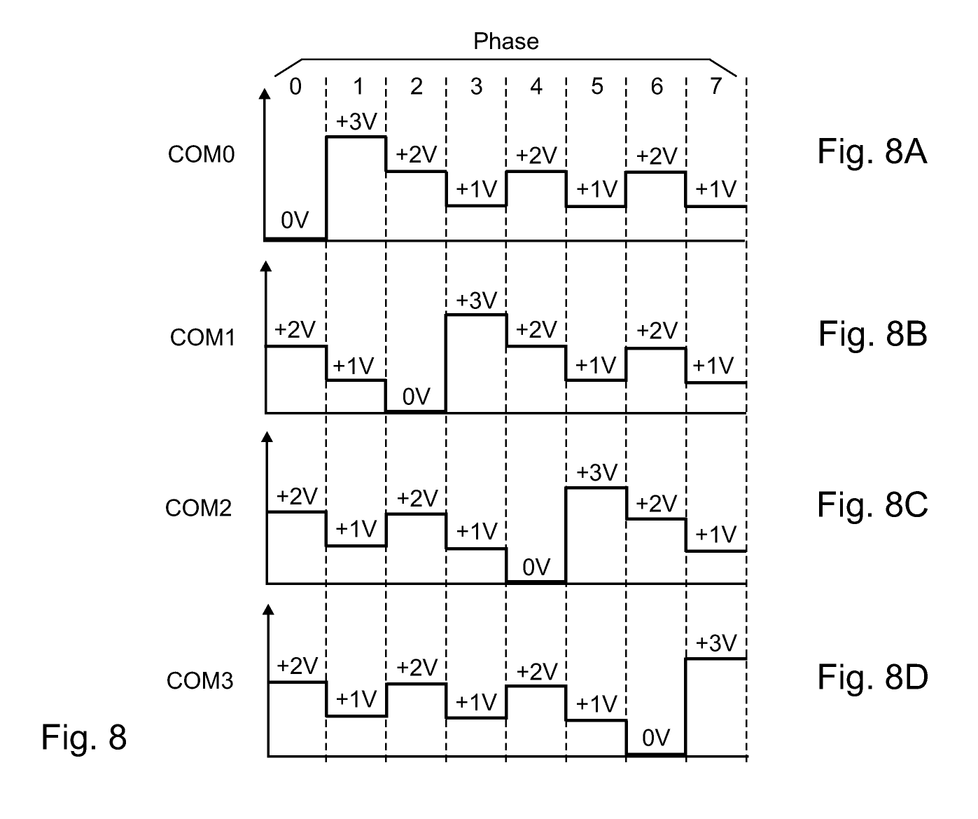

Generally, to remedy additional power dissipation because of parasitics, rather than reset segments by coupling segment capacitors 30 to ground 33 (see FIG. 6), the segments are reset by coupling segment capacitors 30 to a majority voltage for a given phase (e.g., current phase) of operation. In other words, segment resetting is performed by coupling the common and segment lines to the same node (e.g., node 70 in FIG. 7) and/or to the same potential (e.g., output of bias generator 80 in FIG. 7) between phases of operation, where the potential is a majority voltage for a given phase, as discussed below. FIG. 8 shows waveforms used to derive, select, or determine majority voltages.

Specifically, FIG. 8 shows waveforms for common lines COM0-COM3 for an LCD controller. Note that the waveforms in FIG. 8 are similar to the waveforms in FIG. 4, but FIG. 8 shows typical voltage levels for the common lines during various phases, which may be used to select or derive or determine majority voltages.

Referring to the example illustrated in FIGS. 8A-8D, note that during any given phase, three of the four common lines have the same drive voltage, i.e., a majority voltage. For example, during phase 3, common lines COM0, COM2, and COM3 lines are at +1V, the majority voltage for phase 3. As another example, during the succeeding phase, phase 4, common lines COM0, COM1, and COM3 are at +2V, the majority voltage for phase 4.

Thus, during any phase shown, three of the four common lines are at the same potential, the majority voltage, which is either +1V or +2V for the example illustrated. Note that, generally, for the example shown, during even phases the majority voltage is +2V, and during odd phases, the majority voltage is +1V.

In addition, for most but not all transitions shown, the common line not at the majority voltage for a given phase will cross the majority voltage on the next phase transition. For example, during phase 0, with the majority voltage of +2V, COM0 is at 0V. During the next phase transition, COM0 crosses the +2V level as it makes a transition to +3V. As another example, during phase 2, the majority voltage is +2V. During that phase, COM1 has a level of 0V. During the succeeding phase transition, COM1 makes a transition from 0V to 3V through the +2V level.

Thus, during each phase, three of the common lines are at the majority voltage, and during some of the succeeding phase transitions the fourth common line makes a transition through that majority voltage. Using that observation, in some embodiments, one may perform segment resetting by coupling the common and segment lines to the majority voltage for a given phase. As an alternative, in some embodiments, during a given phase, one may perform segment resetting by coupling the common and segment lines to the majority voltage for a succeeding phase.

Segment resetting by using majority voltages provides an additional advantage. Specifically, segment resetting by coupling common and segment lines to majority voltages does not increase parasitic losses associated with the segment lines or does not increase it significantly, since most of the parasitic capacitors will either already be charged to the majority voltage, or will transition to or through the majority voltage during the successive phase. In general, this attribute results in lower power losses due to the parasitic capacitors compared to resetting the LCD segments to an arbitrary voltage, such as 0V.

In a similar manner, resetting the segments by coupling the common and segment lines to the same node, but not driving that same node to a specific bias voltage (e.g. allow the node to float), can also reduce power losses due to parasitics. In sum, the disclosed segment resetting techniques provide a way of reducing power dissipation or decreasing battery drain in portable applications.

As noted, controller 15 controls the various operations associated with segment resetting. One may implement controller 15 a variety of ways. FIG. 9 shows a block diagram of controller 15 according to an exemplary embodiment.

Specifically, controller 15 includes bias generator 80, charge pump 85, phase generator 90, switch controller 100, segment enable circuit 105, host interface circuit 110, common line switches 115, and segment line switches 120. Generally speaking, controller 15 may operate from a given supply voltage, for example, a battery voltage. The supply voltage may or may not correspond to bias or other voltages used to control a given LCD 20. Charge pump 85 generates an output voltage by scaling the input power supply up or down, as desired. In general, the output voltage of charge pump 85 corresponds to the highest voltage provided to the LCD segments (called V_{LCD}), +3V in the example described in connection with FIG. 8. Charge pump 85 provides its output voltage to bias generator 80.

Bias generator 80 provides a set of bias voltages 95, using the output voltage of charge pump 85. In an exemplary embodiment corresponding to the waveforms in FIG. 8, bias voltages 95 may include 0V (ground potential), +1V, +2V, and +3V although, as persons of ordinary skill in the art understand, other levels and/or numbers of voltages may be used.

Referring back to FIG. 9, host interface circuit 110 provides a mechanism for communicating with a host or controller (not shown). The host can control various operations of controller 15, for example, by supplying information that specifies which of the LCD segments should be turned ON or OFF to display the desired information. If desired, host interface circuit 110 may provide information, such as data or status signals, from controller 15 to the host.

The host may have a variety of forms, such as a processor, microcontroller, central processing unit (CPU), etc., as desired. In some embodiments, the host might be internal to controller 15. For example, in some embodiments, controller 15, including the host, may be integrated in an integrated circuit (IC), semiconductor die, etc., as desired.

Segment enable circuit 105 holds information, for example, in the form of register bits, that the host writes to specify the requested state of the LCD segments, e.g., ON or OFF, to generate a desired display. Segment enable circuit 105 provides control signals corresponding to the desired state of the LCD segments to switch controller 100.

Phase generator 90 generates the timing signals corresponding to the different switching phases used by controller 15. For example, for a controller driving four common lines, there are eight phases, 0 through 7, as discussed above. Generally, in exemplary embodiments, phase generator 90 provides control signals to switch controller 100 that cause segment resetting to be performed, as described above. The duration over which segment resetting is performed (the time period for segment resetting between phases), in general, is a fraction of each phase duration, and may be adjustable in some embodiments, as desired.

Switch controller 100 uses the control signals from segment enable circuit 105 and the control signal from phase generator 90 to enable the appropriate switches (described below) during the appropriate phases of operation to provide appropriate bias voltages to the corresponding common and segment lines to ultimately cause the LCD to produce a desired display.

As noted, controller 15 includes common line switches 115 and segment line switches 120. Under the control of switch controller 100, common line switches 115 selectively couple the common lines (e.g., COM0, COM1, . . . , COM3) to a desired or appropriate bias voltage (e.g., 0V, +1V, +2V, or +3V in the exemplary embodiment shown). Furthermore, under the control of switch controller 100, segment line switches 120 selectively couple the segment lines (e.g., SEG0, SEG1, . . . , SEG6) to a desired or appropriate bias voltage (e.g., 0V, +1V, +2V, or +3V in the exemplary embodiment shown). In the exemplary embodiment shown in FIG. 9, one or more of the lines coupled to bias voltages 95 may serve the role of node 70 shown in FIG. 7.

One aspect of the disclosure relates to segment resetting or switching by taking into account the data provided to the LCD. Segment resetting according to the techniques disclosed above can provide relatively high power savings. For example, assuming equally probable random data provided to the LCD/LCD controller, using the techniques might reduce power consumption by 37.5%.

By taking into account the data provided to the LCD or driving the LCD, additional power savings may be obtained. This technique takes advantage of the properties of the voltages applied to the common and segment lines of an LCD. More specifically, the common lines' waveforms are data-independent, i.e., the voltages applied to the common lines of the LCD do not depend on the data that one seeks to display on the LCD.

On the other hand, the segment lines' waveforms are data-dependent. In other words, the nature of the waveforms applied to the segment lines, i.e., the voltages driving the segment lines, depends on the data that one seeks to display on the LCD. Exemplary embodiments take advantage of this property to reduce LCD power consumption.

More specifically, exemplary embodiments of the proposed technique change the resetting or switching of the segment lines based on the data provided to the segment lines or driving the segment lines. Thus, depending on the value of the data driving the segment lines, the segment lines are either reset or kept floating or allowed to float or floated between transitions.

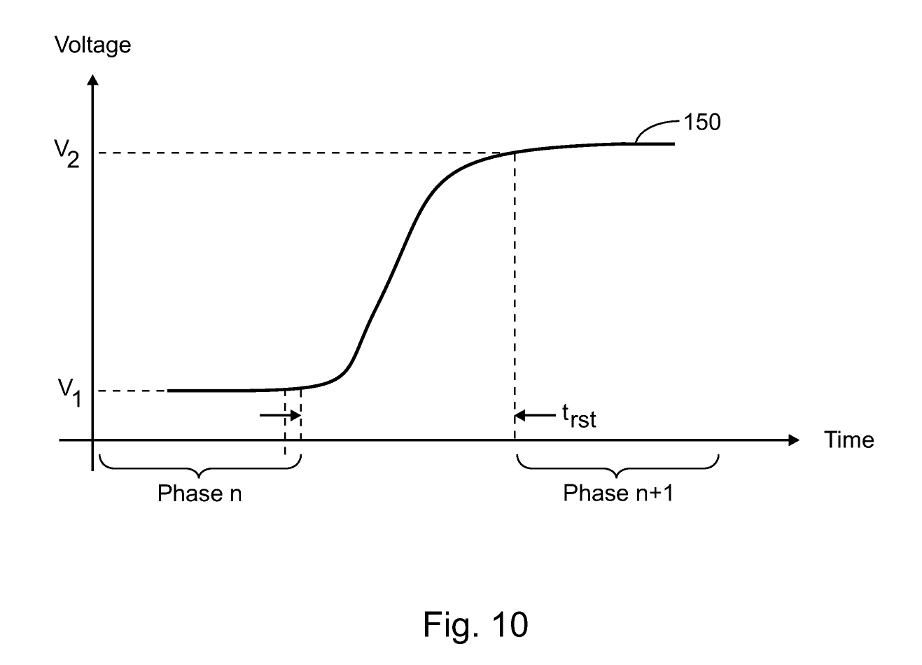

Transitions of the LCD waveforms typically entail a short period of time. FIG. 10 illustrates this time period for an exemplary LCD waveform 150. Waveform 150 makes a transition from voltage V₁ during phase n, where n denotes an integer, to voltage V₂ during phase n+1 of the LCD operation.

Given that the LCD common and segment lines exhibit some capacitance, as described above, waveform 150 does not make an instantaneous transition from voltage V₁ to voltage V₂. Rather, waveform 150 makes the transition during a relatively short (compared to the duration of the phases of LCD operation) time-period, labeled as tᵣₛₜ (reset period) in the figure.

The data driving the segment lines are examined by the LCD controller (e.g., the controller shown in FIG. 9). As described above, several capacitors corresponding to LCD elements (and possibly parasitics) are coupled to the same LCD segment line. For a given segment line, if the segment that is excited (whose common line has a voltage that is different from the voltage of the other common lines) during the current phase and the segment that is to be excited during the following phase both have the same value (either both ON or both OFF), the segment line is kept floating or allowed to float or floated during the reset period. The common lines are coupled to a desired voltage, generally Vᵣₛₜ.

Conversely, if the segment that is excited during the current phase and the segment that is to be excited during the following phase both have opposite or different values (one ON and the other OFF), the segment line is reset during the reset period (tᵣₛₜ) by coupling the segment line to a desired voltage, generally Vᵣₛₜ, as described above. The common lines are coupled to a desired voltage, generally Vᵣₛₜ.

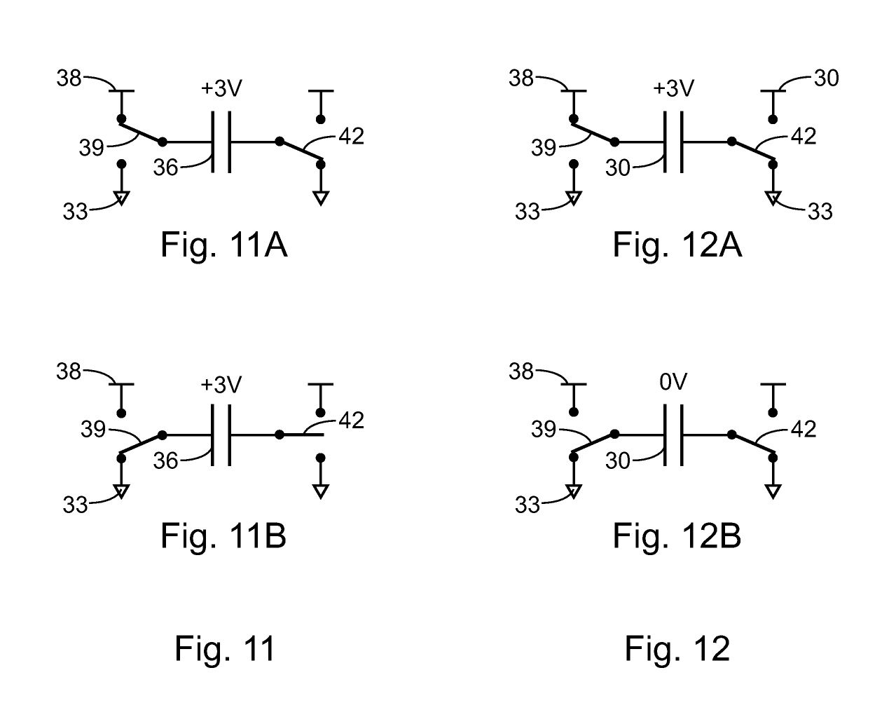

FIGS. 11 and 12 provide details of this technique. FIG. 11, consisting of FIGS. 11A-11B, shows segment switching in the first scenario described above, i.e., the segment that is excited during the current phase and the segment that is to be excited during the following phase both have the same value. More specifically, FIG. 11 shows how the voltage across segment capacitance 36 is switched in response to commands or control signals from a controller (not shown). Switches 39 and 42 are controlled switches, and respond to the LCD controller (not shown). Switches 39 and 42 switch the terminals of capacitor 36 between a supply 38 (in this case, a 3V supply) and a ground potential.

Referring to FIG. 11A, switch 39 couples the left terminal of capacitor 36 to supply 38. Similarly, switch 42 couples the right terminal of capacitor 36 to ground 33. Supply 38 provides charge to capacitor 36. As a result, capacitor 36 charges ultimately to the supply voltage, 3V, with a time constant that depends on circuit component values and parasitic elements, as persons of ordinary skill in the art will understand.

During the reset period, discussed above, the controller (not shown) causes switch 42 to open and for switch 39 to couple to a desired voltage (ground in the example shown), generally Vᵣₛₜ, as described above. (Note that rather coupling to a desired voltage, switch 39 may open, similar to switch 42, to float (or allow to be floated or keep floating) the left terminal of capacitor 36.)

As noted above, if the segment that is excited during the current phase and the segment that is to be excited during the following phase have opposite or different values, the segment line is coupled to Vᵣₛₜ during the reset period (tᵣₛₜ), using one or more of the techniques described above. FIG. 12, which includes FIGS. 12A-12B, shows details of the segment resetting operation in this situation.

More specifically, FIG. 12 shows how the voltage across segment capacitance 30 is switched in response to commands or control signals from controller 15 (not shown). Switches 39 and 42 are controlled switches, and respond to controller 15 (not shown). Switches 39 and 42 switch the terminals of capacitor 30, with a capacitance C, between a supply 38 (in the example shown, a 3V supply) and a ground potential.

Referring to FIG. 12A, during one phase of operation, say, the current phase, controller 15 (not shown) causes switch 39 to couple the left terminal of capacitor 30 to supply 38. Similarly, controller 15 (not shown) causes switch 42 to couple the right terminal of capacitor 30 to ground. As a result, supply 38 provides charge to capacitor 30, causing it to charge ultimately to the supply voltage, 3V in this example, with a time constant that depends on circuit component values and parasitic elements.

Referring to FIG. 12B, the figure illustrates how switches 39 and 42 are configured between the first phase (current phase), and the next phase. More specifically, switch 39 and switch 42 are controlled by controller 15 (not shown) so as to couple the terminals of capacitor 30 to desired nodes, points, or voltages (generally, Vᵣₛₜ). In the example shown, switch 39 and switch 42 are controlled by controller 15 (not shown) so as to couple the terminals of capacitor 30 to ground potential, i.e., to ground 33. This operation does not draw any current or charge from supply 38, as any current flows from one terminal of capacitor 30 through a node (in this example, ground 33), and to the other terminal of capacitor 30.

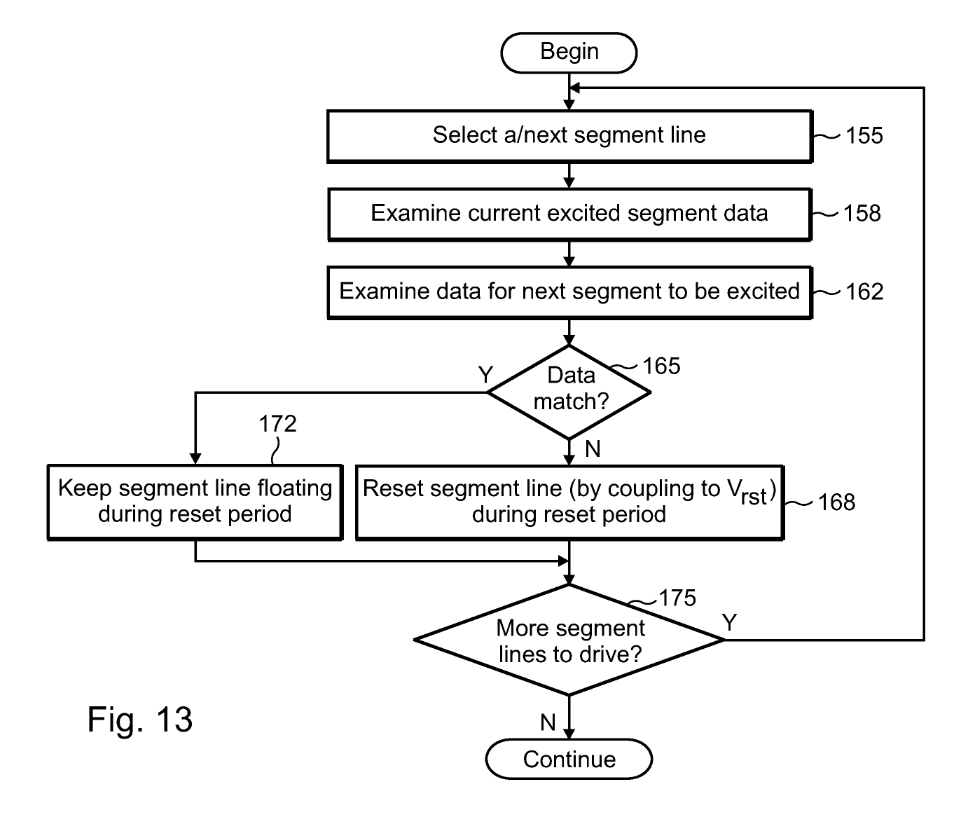

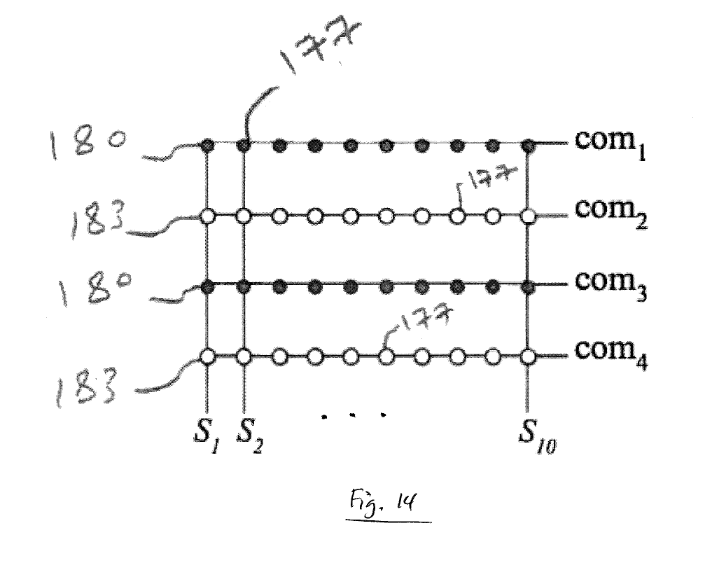

FIG. 13 illustrates a flow diagram for a data-dependent method of LCD segment switching according to an exemplary embodiment. During the reset period, the common lines are coupled to a desired voltage or point or node, generally Vᵣₛₜ, as described above. At 155, a segment line is selected to examine the data for the current excited segment and for the segment to be subsequently excited.

At 158, the data for the current excited segment is examined to determine the data value (e.g., ON, OFF). At 162, the data for the segment to be subsequently excited is examined to determine the data value (e.g., ON, OFF). At 165, a determination is made whether the data match. In other words, a determination is made whether the currently excited segment and the segment to be excited in the subsequent phase match (both ON or both OFF).

If the data match, at 172 the segment line is kept floating or allowed to float or floated during the reset period. Conversely, if the data do not match, at 168 the segment line is coupled to a desired voltage, generally Vᵣₛₜ, during the reset period, tᵣₛₜ, as described above.

At 175, a determination is made whether additional segment lines remain to be processed. If so, control returns to 155 to process the additional segment line(s) as described above.

The method shown in FIG. 13 may be implemented in or realized by the LCD controller. An example of such a controller is shown in FIG. 9. A variety of circuitry and/or firmware may be used to implement the method. For example, in some embodiments, a finite-state machine (FSM) may be used. Other choices of implementation exist, such as processors, programmable logic, and the like. The choice of implementation depends on a variety of factors, such as cost, complexity, available technology, desired performance specifications, and the like, as persons of ordinary skill in the art will understand.

The data-dependent segment-resetting technique described above provides additional power savings compared to the resetting technique that does not take into account LCD data values. In some embodiments, compared to the data-independent resetting technique, the data-dependent segment-resetting technique may provide 30% to 35% reduction in power consumption. The data-independent resetting technique according to exemplary embodiments provides a power savings of 37.5% over conventional LCDs. Thus, overall, compared to conventional LCDs, the data-dependent segment-resetting technique provides a 56.25% power savings.

Another aspect of the disclosure relates to a refinement of the data-dependent segment resetting or switching technique described above. Specifically, the data-dependent segment resetting or switching technique results in the LCD's using less power if two consecutive segments in the segment line (e.g., segment that is excited during the current phase and the segment that is to be excited during the following phase) are either ON or OFF. In exemplary embodiments, by modifying the scan (drive) order of the LCD common lines, additional power savings may be obtained.

Conventional LCDs scan (drive) the common lines in consecutive order. For example, a conventional LCD with four common lines com₁ through com₄ scans the lines in the order com₁, com₂, com₃, and com₄. Rather than the sequential or consecutive scanning of the common lines, exemplary embodiments change the scan order based on LCD data values, as described below in detail, with reference to an LCD shown in FIG. 14.

Specifically, the LCD in FIG. 14 includes four common lines, com₁-com₄, and ten segment lines, S₁-S₁₀. In the example shown, circles represent generally segments 177 at the intersection of a common line and a corresponding segment line. Segments 180 are driven by corresponding data values to be in the OFF condition. Conversely, segments 183 are driven by corresponding data values to be in the ON condition.

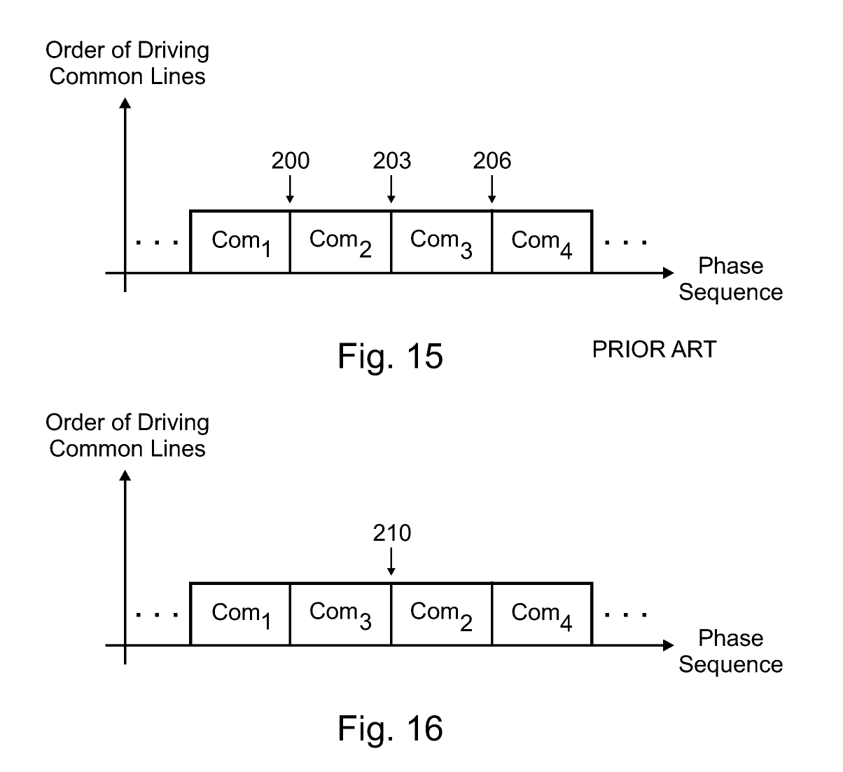

As noted, a conventional LCD controller would scan the common lines in the consecutive sequence 1, 2, 3, 4, regardless of the segment data. FIG. 15 shows the common line scan order for such an LCD controller. Thus, the conventional LCD controller would drive common line com₁, followed by common line comₘ, common line com₃, and finally common line com₄.

Given the configuration of segment data in FIG. 14, driving of the common lines according to the conventional scheme results in three transition between the OFF and ON states. Specifically, referring to FIG. 15, an OFF-to-ON transition occurs at point 200, i.e., when the controller finishes scanning com₁, and proceeds to drive comₘ. Similarly, an ON-to-OFF transition occurs at point 203. Another OFF-to-ON transition occurs at point 206. As described above, the OFF-ON or ON-OFF transitions result in an increase in the power consumption of the LCD.

In contrast, exemplary embodiments take into account the segment data in selecting the order of common-line scanning. FIG. 16 shows a common-line scanning sequence according to an exemplary embodiment.

As FIG. 16 illustrates, the controller drives common line com₁, followed by common line com₃, common line com₂, and finally common line com₄. The controller selects the common-line scanning order based on the configuration of segment data. Referring to the data configuration shown in FIG. 14, the controller determines that common lines 1 and 3 correspond to a segment-OFF configuration, whereas common lines 2 and 4 correspond to a segment-ON configuration. The controller then determines the order or sequence of driving or scanning the common lines so as to reduce or minimize the number of transitions between the segment ON and OFF states.

Given the example configuration of segment data in FIG. 14, driving of the common lines in the manner shown in FIG. 16 results in one transition between the OFF and ON states. Specifically, referring to FIG. 16, an OFF-ON transition occurs at point 210, i.e., when the controller finishes scanning com₃, and proceeds to drive com₂.

Compared to the conventional scan approach (see FIG. 15), the reordering of the scan of the common lines as shown in FIG. 16 results in fewer segment-line transitions, i.e., transitions between the OFF and ON states. As described above, a decrease in the number of transitions between the OFF and ON states results in a decrease in the power consumption of the LCD.

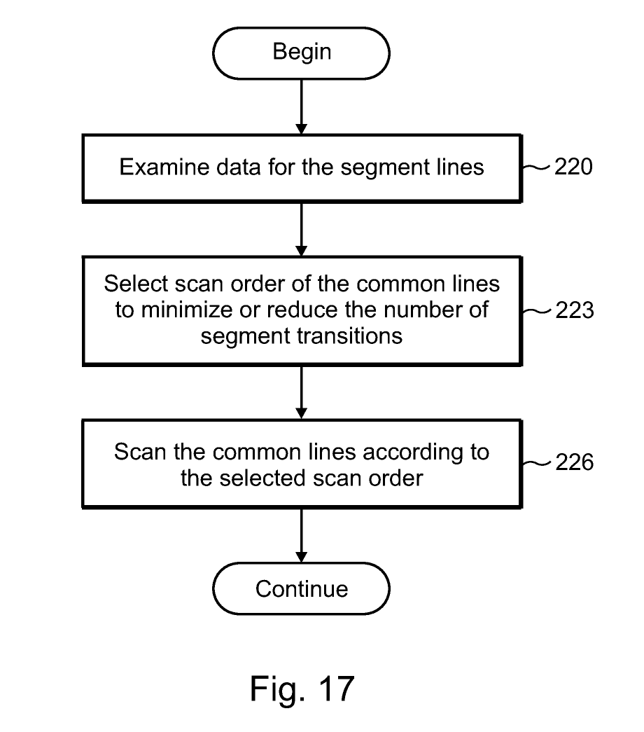

FIG. 17 shows a flow diagram for a data-dependent method of common-line scanning according to an exemplary embodiment. At 220, the data for the segment lines is examined in order to select a scan order for the common lines.

At 223, a scan order for the common lines is selected so as to minimize or reduce the number of segment state transitions (OFF-ON or ON-OFF transitions). At 226, the common lines are scanned according to the selected scan order.

The method shown in FIG. 17 may be implemented in or realized by the LCD controller. An example of such a controller is shown in FIG. 9. A variety of circuitry and/or firmware may be used to implement the method. For example, in some embodiments, a finite-state machine (FSM) may be used. Other choices of implementation exist, such as processors, programmable logic, and the like. The choice of implementation depends on a variety of factors, such as cost, complexity, available technology, desired performance specifications, and the like, as persons of ordinary skill in the art will understand.

The segment resetting techniques disclosed may be applied in a variety of arrangements. For example, although the figures show common and segment lines that correspond to an exemplary LCD, persons of ordinary skill in the art understand that a variety of other numbers of common and segment lines may be used, depending on a particular implementation. Furthermore, the multiplexing scheme (2MUX, etc.) and/or biasing scheme (⅓ bias, etc.) may be implemented in a number of ways, depending on factors such as the type of a given LCD, etc.

Similarly, the number and levels of bias voltages, whether used for segment resetting or otherwise to control the LCD, may be selected and implemented in a number of ways, as desired. The number of phases of operation, supply voltage(s), and the like may also be selected depending on factors such as the specifications for a given implementation, etc., as persons of ordinary skill in the art understand.

Referring to the figures, persons of ordinary skill in the art will note that the various blocks shown might depict mainly the conceptual functions and signal flow. The actual circuit implementation might or might not contain separately identifiable hardware for the various functional blocks and might or might not use the particular circuitry shown. For example, one may combine the functionality of various blocks into one circuit block, as desired. Furthermore, one may realize the functionality of a single block in several circuit blocks, as desired. The choice of circuit implementation depends on various factors, such as particular design and performance specifications for a given implementation. Other modifications and alternative embodiments in addition to those described here will be apparent to persons of ordinary skill in the art. Accordingly, this description teaches those skilled in the art the manner of carrying out the disclosed concepts, and is to be construed as illustrative only.

The forms and embodiments shown and described should be taken as illustrative embodiments. Persons skilled in the art may make various changes in the shape, size and arrangement of parts without departing from the scope of the disclosed concepts in this document. For example, persons skilled in the art may substitute equivalent elements for the elements illustrated and described here. Moreover, persons skilled in the art may use certain features of the disclosed concepts independently of the use of other features, without departing from the scope of the disclosed concepts.

1. An apparatus, comprising a multiplexed liquid crystal display (LCD) controller operating in at least first and second phases of operation, the LCD controller to drive a first plurality of signal lines to a first set of voltages during the first phase of operation and to a second set of voltages during the second phase of operation, wherein the LCD controller selectively couples to a node at least some of the first plurality of signal lines between the first and second phases of operation depending on data provided to the LCD controller.

2. The apparatus according to claim 1, wherein the first plurality of signal lines comprises a plurality of segment lines.

3. The apparatus according to claim 1, wherein a period of time between the first and second phases of operation comprises a reset period.

4. The apparatus according to claim 1, wherein the at least some of the first plurality of signal lines are floated between the first and second phases of operation if data for a segment excited during the first phase of operation matches data for a segment to be excited during the second phase of operation.

5. The apparatus according to claim 4, wherein the at least some of the first plurality of signal lines are coupled to the node between the first and second phases of operation if data for a segment excited during the first phase of operation differs from data for a segment to be excited during the second phase of operation.

6. The apparatus according to claim 1, wherein an order of scanning a second plurality of signal lines is selected depending on the data provided to the LCD controller.

7. The apparatus according to claim 6, wherein the second plurality of signal lines comprises a plurality of common lines.

8. The apparatus according to claim 6, wherein the order of scanning a second plurality of signal lines is selected depending on whether data for a segment excited during the first phase of operation differs from data for a segment to be excited during the second phase of operation.

9. The apparatus according to claim 1, wherein the LCD controller selectively couples the first plurality of signal lines to (a) a ground potential; or (b) a majority voltage of a plurality of common lines for the first phase of operation; or (c) a majority voltage of a plurality of segment lines for the second phase of operation.

10. An apparatus, comprising:
a multiplexed liquid crystal display (LCD), having at least first and second phases of operation; and
a controller coupled to the LCD, wherein the controller is to selectively perform segment resetting between the first and second phases of operation of the LCD depending on data provided to the LCD controller.

11. The apparatus according to claim 10, wherein the controller performs segment resetting by selectively coupling a plurality of segment lines of the LCD to a voltage if data for a segment excited during the first phase of operation differs from data for a segment to be excited during the second phase of operation.

12. The apparatus according to claim 11, wherein the controller floats the plurality of segment lines of the LCD between the first and second phases of operation if data for a segment excited during the first phase of operation matches data for a segment to be excited during the second phase of operation.

13. The apparatus according to claim 12, wherein an order of scanning a second plurality of signal lines of the LCD is selected depending on the data provided to the LCD controller.

14. The apparatus according to claim 13, wherein the second plurality of signal lines of the LCD comprises common lines of the LCD.

15. The apparatus according to claim 11, wherein the voltage comprises (a) a ground potential of the apparatus, (b) a bias voltage, (c) a majority voltage of common lines of the LCD, or (d) a majority voltage of the segment lines of the LCD.

16. The apparatus according to claim 10, wherein the controller performs segment resetting by selectively coupling a plurality of segment lines of the LCD to a plurality of common lines of the LCD.

17. A method of operating a liquid crystal display (LCD), the method comprising:
operating the LCD in a first phase of operation;
after operating the LCD in the first phase of operation, selectively performing segment resetting based on data provided to the LCD controller; and
operating the LCD in a second phase of operation after performing selective segment resetting.

18. The method according to claim 17, wherein performing segment resetting further comprises selectively coupling a plurality of segment lines of the LCD to a voltage if data for a segment excited during the first phase of operation differs from data for a segment to be excited during the second phase of operation.

19. The method according to claim 18, wherein the controller floats the plurality of segment lines of the LCD between the first and second phases of operation if data for a segment excited during the first phase of operation matches data for a segment to be excited during the second phase of operation.

20. The method according to claim 19, further comprising selecting an order of scanning a plurality of common lines of the LCD depending on the data provided to the LCD controller.
